(19) United States
(12) Patent Application Publication
(10) Pub. No.: US 2017/0213552 A1
(43) Pub. Date: Jul. 27, 2017

(54) DETECTION OF AUDIO PUBLIC ANNOUNCEMENTS BY A MOBILE DEVICE

(71) Applicant: Motorola Mobility LLC, Chicago, IL (US)

(72) Inventors: Ranjeet Gupta, Chicago, IL (US); Sudhir C Vissa, Bensenville, IL (US)

(21) Appl. No.: 15/006,229

(22) Filed: Jan. 26, 2016

(51) Int. Cl. G10L 15/22; H04W 4/02; G10L 15/28; G10L 15/30; G10L 15/26; H04W 52/02; H04L 29/06

(52) U.S. Cl. CPC G10L 15/22; H04W 52/0225; H04W 4/02; H04L 65/4084; G10L 15/30; G10L 15/26; G10L 15/285

(57) ABSTRACT

A mobile device runs audio recognition while operating in a low power state. A mobile device processor will wake from the low power state in response to detecting an audio trigger corresponding to an audio public announcement at a location of the mobile device. The mobile device will receive the audio public announcement and display a text version of the audio public announcement on the mobile device display.

### FIELD OF THE DISCLOSURE

The present disclosure relates generally to public address systems, and more particularly to mobile devices receiving information from such public address systems.

### BACKGROUND

Almost all mobile device users have had the experience of being distracted in a setting such as a train station, airport or public gathering and missing public announcements being made over a public address system. An additional experience that most mobile device users have had is being unable to hear such announcements in a noisy environment. In some cases, a user is focused on surrounding entertainment or in conversation with another person. Alternatively, a distracted user may be listening to music or taking a call. Because of these issues, the intended audience sometimes misses public announcements in train station, airports and restaurants.

In other public venues, such as schools and shopping malls, emergency broadcasts may be transmitted that require immediate evacuation. A distracted user may miss the announcement and be placed in a dangerous situation.

### BRIEF DESCRIPTION OF THE DRAWINGS

FIG. 1 is a diagram showing a mobile device receiving audio public announcements through a microphone and displaying a text version of the announcement on the mobile device display.

FIG. 2 is a diagram showing a mobile device connecting with a server in order to obtain audio templates in accordance with an embodiment.

FIG. 3 is a diagram showing a mobile device connecting with a server in order to obtain text versions or audio streams of audio public announcements in accordance with an embodiment.

FIG. 4 is a flowchart of an example method of operation of a mobile device in accordance with an embodiment.

FIG. 5 is a flowchart of an example method of operation of a mobile device having a public announcement module in accordance with an embodiment.

FIG. 6 is a diagram of a mobile device in accordance with an embodiment.

FIG. 7 is a flowchart of a method of operation of a mobile device in accordance with an embodiment.

FIG. 8 is a flowchart of a method of operation of a mobile device in accordance with an embodiment.

FIG. 9 is a flowchart of a method of operation of a mobile device in accordance with an embodiment.

### DETAILED DESCRIPTION

Briefly, a disclosed mobile device listens, via at least one microphone and internal audio equipment, for audio public announcements broadcast in the surrounding area over a public address system. The mobile device is operative to send its location information to a server and, in response, obtain at least one audio template from the server. Low power operations, such as basic audio recognition, run on the mobile device while the mobile device's primary processor is in a sleep mode. A basic audio recognition engine, operating while the processor is in a sleep mode, listens for an audio trigger that matches either a predetermined audio trigger defined by the audio template, or that matches a portion of the audio template. Detection of the trigger wakes the processor in order to display text versions of the audio public announcements on the mobile device display. In some embodiments, an audio template received from the server may have an associated text version attached, which can be directly displayed on the mobile device display when the associated audio trigger is detected. Alternatively, the mobile device can store an audio file of the audio public announcement in memory and perform a voice-to-text operation to convert the audio file into a displayable text version. Examples of audio public announcements may include, but are not limited to sounds, spoken words (either human speech or synthesized speech), music, combinations thereof, and the like.

One disclosed method includes running audio recognition on a mobile device that is operating in a low power state, waking a processor in response to detecting an audio trigger corresponding to an audio public announcement at a location of the mobile device, receiving the audio public announcement and displaying a text version of the audio public announcement on a display of the mobile device. In some embodiments, the audio templates, which define the audio trigger related to a public address system, may be obtained from a server based on location of the mobile device. An audio trigger may be a spoken word, phrase, sound or combination thereof from a public address system.

A disclosed mobile device includes at least one microphone, a display and a first processor, operatively coupled to the microphone and to the display. The first processor is operative to receive an audio public announcement and display a text version of the audio public announcement on the display. The disclosed mobile device also includes a second processor, operatively coupled to the first processor, the microphone and to the display. The second processor is operative to run audio recognition while the first processor operates in a low power state, and wake the first processor from the low power state in response to an audio trigger detected using the microphone. The audio trigger corresponds to an audio public announcement at a location of the mobile device.

The first processor is further operative to obtain an audio template from a server based on location of a mobile device. The audio template is used to define the audio trigger related to a public address system at the location.

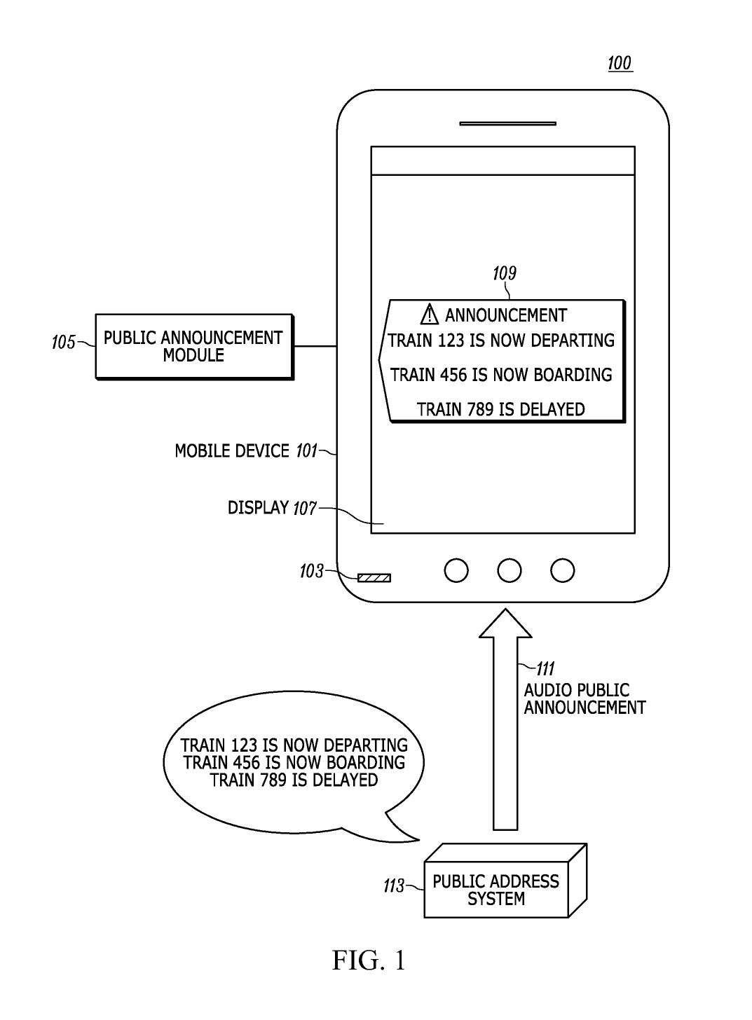

Turning now to the drawings wherein like numerals represent like components, FIG. 1 illustrates a mobile device 101 and a public address system 113 at a location 100. The mobile device 101 includes a public announcement module 105 and at least one microphone 103 for receiving an audio public announcement 111. In one embodiment, the public announcement module 105 will obtain one or more audio templates (also referred to herein as “audio signatures”) from a server based on the location 100 of the public address system 113 for use by the mobile device 101 when it is at location 100. The public address system 113 at the location 100 may broadcast an audio public announcement 111 which will be detected by the microphone 103. The mobile device 101 will detect the audio public announcement 111 and match the audio public announcement 111 with one of the obtained audio templates, or with a portion of the audio template that has been defined as an audio trigger. The terms “audio template” and “audio trigger” as used herein both refer to audio signatures. An “audio trigger” refers to an audio template or a portion (or segment) or an audio template that has been defined as an “audio trigger” for the purpose of invoking some action in the mobile device 101. After detection of an audio template or audio trigger by the mobile device 101, a text version 109 of the audio public announcement 111 will then be presented to the user on the display 107. In the example shown in FIG. 1, three audio public announcements 111 have been broadcast by the public address system: “Train 123 is now departing”; “Train 456 is now boarding”; and “Train 789 is delayed.” Accordingly, the public announcement module 105 displays these audio public announcements on the display 107 as a text version 109. In some embodiments, the audio public announcements 111 may also be played over a speaker of the mobile device 101 or over an attached headset.

The terms “audio public announcement” and “public announcement” as used herein refers to an audio announcement broadcast openly, using a public address system having speakers at the location of the mobile device. Examples of locations having such public address systems are airports, train stations, bus stations, hotel lobbies, restaurant waiting areas, etc. Examples of public announcements may include, but are not limited to, voice announcements made in train or bus stations or airports, as well as information provided by signs, banners, sound, music, video, combinations thereof, and the like. Voice announcements may be actual human speech or may be synthesized speech. For example train stations usually have voice public announcements when a train is approaching the station that may inform passengers of the train number, destination, boarding and departure times or some subset combination of these, etc. Many such systems employ synthesized speech provided by the public address system rather than having a human announcer at each train station. In another example, airports usually have voice public announcements when a plane is ready for passenger boarding. In other words an “audio public announcement” is a “public announcement” that is an announcement made over a public address system and broadcast over one or more speakers of the public address system. The public announcement may be made by a person speaking over the public address system or may be an automated message that is played over the public address system using a text-to-voice converter used to simulate a human speaker (i.e. synthesized speech). Text files used for automated public announcements may be stored in components of a public address system such as public address system 113 shown in FIG. 1. These text files may be arranged in required orders, combined as needed, and converted to audio using text-to-voice conversion, to create voice announcements that are broadcast at appropriate times over the public address systems 113. Therefore, the “public address system” 113 shown in FIG. 1 includes at least one audio speaker and may also include hardware that determines, from a set of predetermined announcements, which announcements are to be played and when, in response to detected conditions (such as train arrivals and departures for a train station location example, etc.)

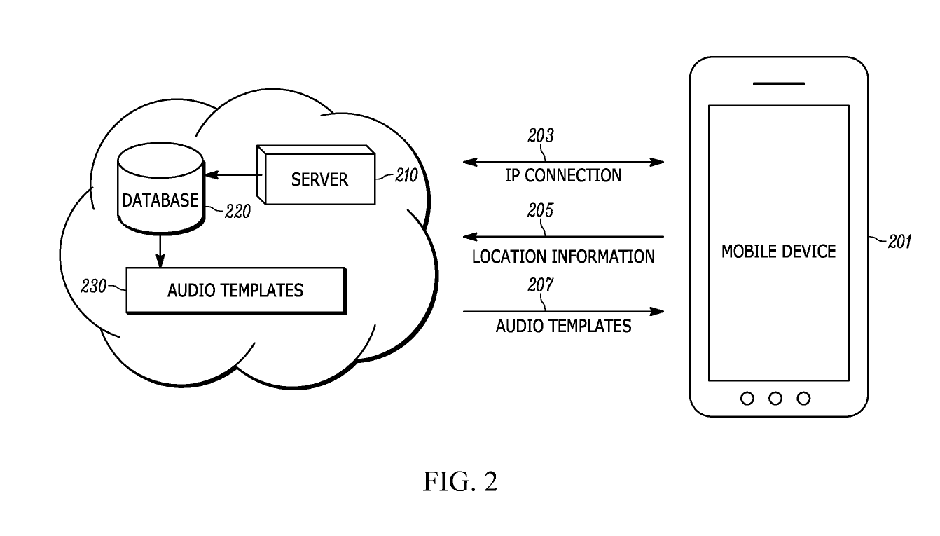

In FIG. 2, a mobile device 201 is operative to obtain audio templates 207 from a server 210 in accordance with various embodiments. In accordance with the example embodiment of FIG. 2, the mobile device 201 will determine its location using GPS hardware or by obtaining location information from a wide area network (WAN) or a wireless local area network (WLAN). In some embodiments, the mobile device 201 may also obtain the user's travel information and upcoming destinations via a calendar application, emailed itineraries, etc. The mobile device 201 is operative to communicate with the server 210 using an Internet Protocol (IP) connection 203 over either a WAN or WLAN wireless connection. The server 210 is operative to access a database 220 with audio templates 230, and other information in some embodiments, pertaining to audio public announcements used by public address systems at one or more locations. The database 220 may be integrated with the server 210 or may be separate and operatively coupled to the server 210. The database 220 may be distributed, remotely located, or both, in some embodiments, such as for example in a cloud based implementation.

In the example illustrated in FIG. 2, the mobile device 201 initiates the IP connection 203 with the server 210 and sends its location information 205. In some embodiments a request for audio templates may be sent along with the location information 205. In response to receiving the location information 205, the server 210 accesses the database 220 and retrieves one or more of the audio templates 230 related to a public address system at the mobile device 201 location. The audio templates 230 are audio signatures for voice announcements and, in some embodiments, other sounds that are used by the public address system at the mobile device 201 location. For example, an audio signature may be for a sound (such as a bell, chime, etc.) that is played prior to a human or synthesized speech segment of an audio public announcement. The server 210 then sends the appropriate audio templates 207 to the mobile device 201 for the mobile device 201 location. The mobile device 201 can then use the audio templates 207 as triggers to initiate processes such as running voice-to-text conversion on detected speech, etc.

Thus FIG. 2 illustrates that, in response to the mobile device 201 sending its location information 205, the server 210 will send audio templates 207 related to a public address system at the location of the mobile device 201. More particularly, the audio templates 207 are audio signatures that correspond to audio public announcements played from time-to-time by a public address system at the location of the mobile device 201. The mobile device 201 may subsequently enter a low power state and listen for audio triggers based on all or a portion of the audio templates. For example, the beginning of a train station announcement may begin with a bell sound. If the mobile device 201 detects the bell sound by matching the sound with the audio template, the mobile device 201 may wake from the low power state such that it may receive the entire audio public announcement. The audio public announcement may then be displayed to the user on the mobile device 201 display. In some embodiments, this is accomplished by performing a voice-to-text conversion of the verbal portion of the audio public announcement. In some embodiments, the mobile device 201 may also sample the audio public announcement and play it back over the mobile device 201 speakers or over an attached headset.

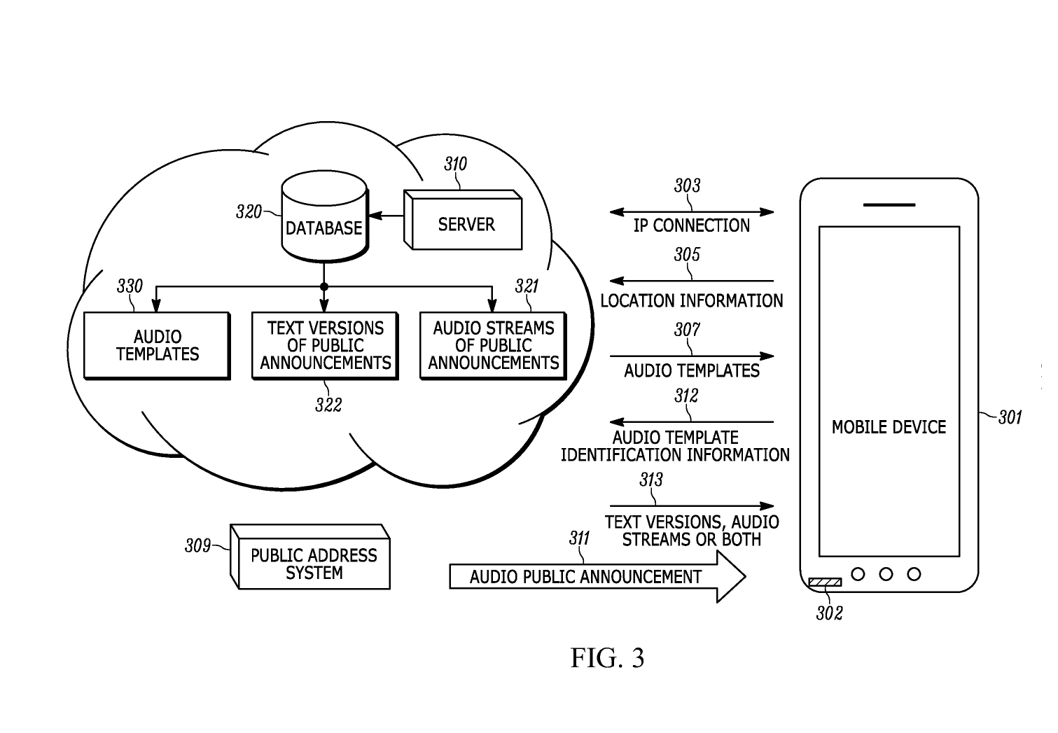

FIG. 3 relates to an example embodiment, in which a mobile device 301 maintains communication with a server 310 such that the mobile device 301 may receive audio streams, text versions, or both, of audio public announcements 311 used by a public address system 309 which is nearby the mobile device 301. The audio streams and text versions are related to automated public address systems that use prerecorded voice messages, or that synthesize a human voice using text-to-speech conversion. The database 320 contains audio templates 330 (i.e. audio signatures), segments of audio public announcements stored as text versions of public announcement 322 and/or audio streams of public announcements 321. These text or audio segments are predetermined segments that may be used to construct any appropriate audio public announcement applicable for a given public address system. In the example of FIG. 3, the mobile device 301 may access the database 320, by way of the server 310, and directly obtain the audio streams or text versions for playback or display by the mobile device 301. The mobile device 301 may either receive an audio stream from the server 310, or may store certain audio streams in mobile device 301 memory for playback when appropriate. Likewise the text versions may either be accessed from the database 320 when needed, or may be downloaded and stored temporarily in mobile device 301 memory. The mobile device 301 may send location information 305 and initially obtain one or more audio templates 307 for use as audio recognition triggers.

In one example embodiment illustrated by FIG. 3, the mobile device 301 initiates and maintains an IP connection 303 with the server 310 and listens for an audio public announcement 311 from the public address system 309. If the mobile device 301 detects a match between some segment of an audio public announcement 311 and an audio template stored in the mobile device 301 memory, then in response to detecting the match, the mobile device 301 will send audio template identification information 312 to the server 310. The server 310 will perform a lookup operation in database 320 using the audio template identification information 312 and will search the audio streams of public announcements 321 and the text versions of public announcements 322 depending on whether one or the other, or both, are available. The server 310 will then send any corresponding audio stream or corresponding text version (or both) to the mobile device 301 as public announcement data (i.e. text versions, audio streams or both 313). If a text version is returned in public announcement data (i.e. text versions, audio streams or both 313), then the mobile device 301 will display the text version on the display and may perform a text-to-speech conversion to play the public announcement also. If an audio stream is returned then the mobile device may play the audio stream and may also perform a voice-to-text conversion to display a text version. If both an audio stream and a text version are returned in public announcement data (i.e. text versions, audio streams or both 313) the mobile device 301 may both play audio and display text for the public announcement, or may do one or the other depending upon mobile device 301 settings. As can be understood, the above scenarios provide for various approaches to presenting the public announcement data (i.e. text versions, audio streams or both 313) to the user depending on whether audio or text versions are available and depending on settings of the mobile device 301 also in some embodiments. In some embodiments, the server 310 may communicate with the public address system 309 and the database 320 may be part of the public address system 309 also in some embodiments.

In another embodiment illustrated by FIG. 3, the mobile device 301 maintains the IP connection 303 with the server 310 but not send any location information 305. Instead, the mobile device 301 samples any audio detected over the microphone 302 and creates an audio signature of an initial segment of the audio. The mobile device 301 then sends this audio signature to the server 310 as the audio template identification information 312. The server 310 performs a search of the audio templates 330 in the database 320 to find a match with the received audio signature. If a match is found, then the server 310 sends any corresponding text versions, audio streams or both 313 to the mobile device 301.

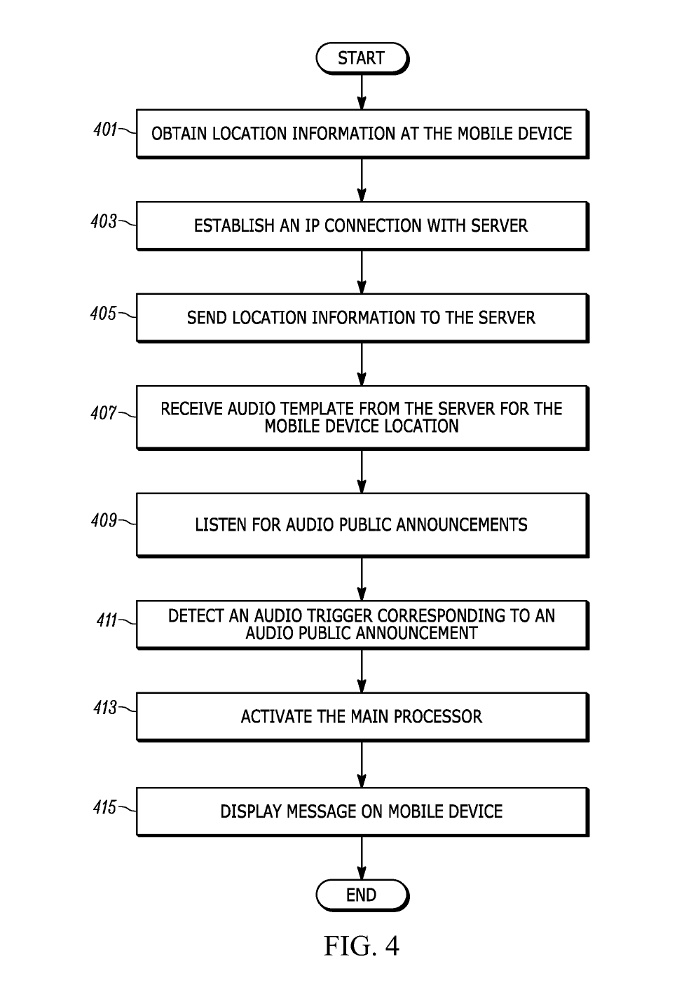

An example method of operation of the mobile device 201 shown in FIG. 2 for obtaining audio templates from the server 210 is illustrated by the flowchart of FIG. 4. The method of operation begins and in operation block 401, the mobile device 201 obtains location information 205. In operation block 403, the mobile device 201 establishes an IP connection 203 with the server 210, and in operation block 405, sends the location information 205 to the server 210. The server 210 uses the location information 205 to perform a database 220 search within the stored audio templates 230 for any audio templates that correspond to a public address system at the location of the mobile device 201. In operation block 407, the mobile device 201 receives one or more audio templates 207 sent by the server 210 in response to having received the location information 205.

The audio templates 207 are audio signatures but the server 210 may also send audio stream files and text message files that correspond to the audio templates 207 such that the mobile device 201 may store the files in memory. In operation block 409, the mobile device 201 listens for audio public announcements by comparing received audio with all or segments of the audio templates 207. When an audio template 207 matches audio received by the mobile device 201, the mobile device 201 takes some further action.

In other words, the mobile device 201 uses the audio templates 207 as audio triggers that trigger specific actions by the mobile device 201. For example, when the mobile device 201 is placed in a sleep mode to conserve power, the audio templates 207 may be used as audio triggers that wake the mobile device 201 from the sleep mode such that it may perform some further action. In operation block 411, the mobile device 201 may detect an audio trigger where the audio trigger is defined as all, or a portion of, one of the audio templates 207 received from the server 210. At operation block 413, the mobile device 201 main processor is activated (i.e. waken from sleep mode) in response to detecting the audio trigger. In operation block 415, the mobile device 201 may display the public announcement as text, play an audio stream stored in memory or both. The mobile device 201 may also continue to sample the audio public announcement in some embodiments. As discussed above, speech-to-text or text-to-speech conversions may be involved in these operations in some embodiments depending on the information available to the mobile device 201 in conjunction with the audio templates 207.

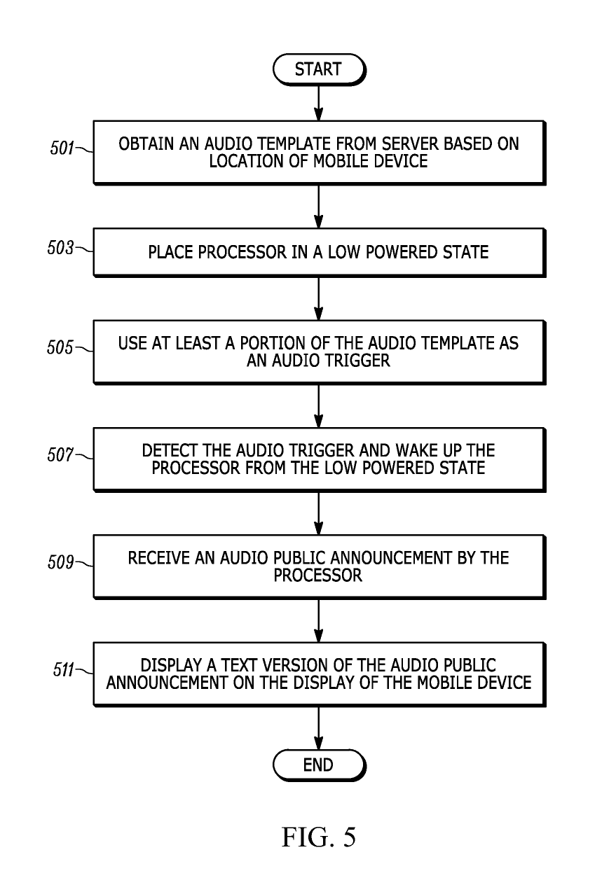

Another method of operation of a mobile device in accordance with an embodiment is illustrated in FIG. 5. The method of operation begins and in operation block 501, the mobile device obtains an audio template from a server based on location of the mobile device. The audio template is related to audio public announcement segments used by a public address system at the mobile device location. In operation block 503, the mobile device processor is placed in a low powered state, i.e. sleep mode. The processor remains in sleep mode until some predetermined trigger is detected that wakes the processor. In accordance with the embodiments, one such trigger is an audio trigger related to audio public announcements. In operation block 505, the audio template, or a portion thereof, is used as an audio trigger. In operation block 507, the audio trigger is detected and the processor is awakened from the low powered state. In operation block 509, the mobile device receives an audio public announcement which is processed accordingly by the processor by, for example, performing a speech-to-text conversion to obtain a text version of the audio public announcement. In operation block 511, the processor may display the text version of the audio public announcement on the mobile device display and may also perform other actions.

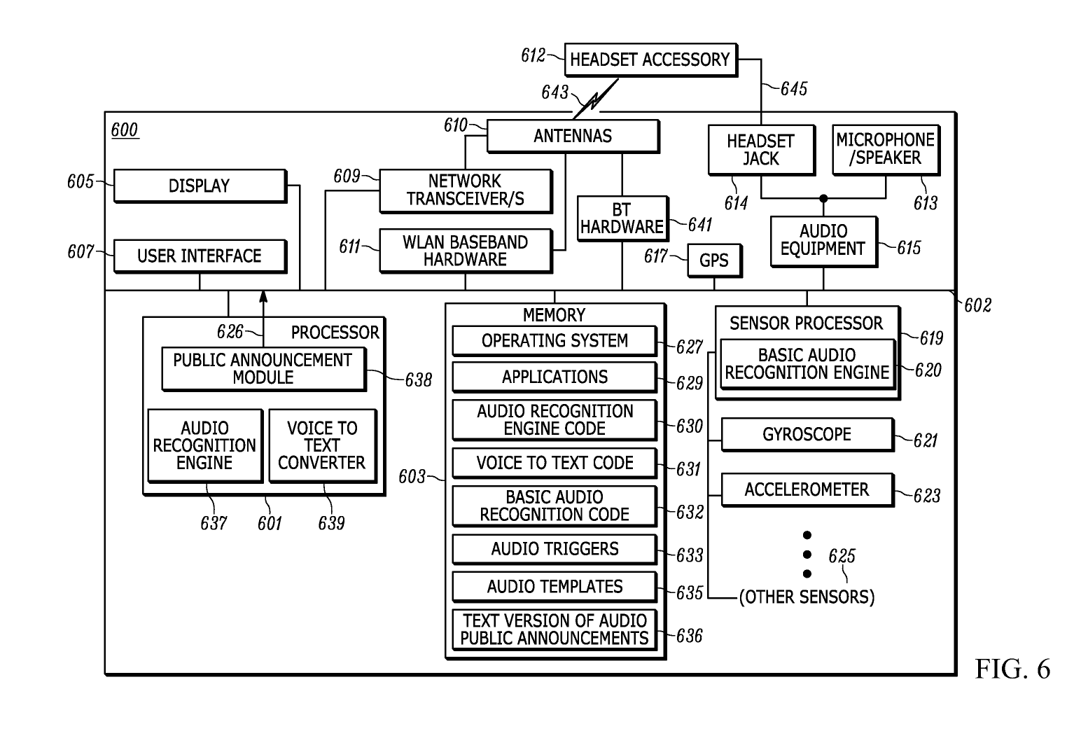

FIG. 6 is a diagram of a mobile device 600 in accordance with various embodiments. The mobile device 600 includes at least one processor 601, display 605, user interface 607, one or more wide area network (WAN) transceivers 609 (such as, but not limited to CDMA, UMTS, GSM, LTE, etc.), WLAN baseband hardware 611, GPS hardware 617, non-volatile, non-transitory memory 603, audio equipment 615, and a sensor processor 619. Bluetooth® hardware 641 may operate as a cable replacement technology to enable use of a wireless headset accessory 612 via a Bluetooth® wireless connection 643. Alternatively, a headset accessory 612 may be connected via a wire connection 645 connected to a headset jack 614. The headset jack is operatively coupled to the audio equipment. 615. The WAN transceivers 609, WLAN baseband hardware 611 and Bluetooth® hardware 641 are all operatively coupled to one or more antennas 610.

Microphones and speakers 613, which include at least one speaker, and at least one microphone, are operatively coupled to audio equipment 615. The audio equipment 615 may include, among other things, signal amplification, analog-to-digital conversion/digital audio sampling, echo cancellation, other audio processing, etc., which may be applied to one or more microphones and/or one or more speakers of the mobile device 600.

All of the mobile device 600 components shown are operatively coupled to the processor 601 by one or more internal communication buses 602. In some embodiments, the separate sensor processor 619 (rather than the main processor or application processor such as processor 601) monitors sensor data from various sensors including a gyroscope 621 and an accelerometer 623 as well as other sensors 625. The gyroscope 621 and accelerometer 623 may be separate or may be combined into a single integrated unit.

The memory 603 is non-volatile and non-transitory and stores executable code for an operating system 627 that, when executed by the processor 601, provides an application layer (or user space), libraries (also referred to herein as “application programming interfaces” or “APIs”) and a kernel. The memory 603 also stores executable code for various applications 629, such as voice-to-text converter code 631, audio recognition engine code 630 and basic audio recognition engine code 632. The applications 629 may also include, but are not limited to, a web browser, email client, calendar application, etc. The memory may also store various text files and audio files, such as, but not limited to, text versions of audio public announcements 636. The memory may also store audio streams for segments of audio public announcements in some embodiments. The memory 603 also stores audio signatures such as audio triggers 633 and audio templates 635. The audio triggers 633 are abbreviated audio signatures that are used to wake the processor 601 from sleep mode, and may be portions or segments of the audio templates 635 in some embodiments.

The processor 601 is operative to execute and run a public announcement module 638. The public announcement module 638 may be one of the applications 629 stored in memory 603. The processor 601 is also operative to execute the audio recognition engine code 630 to run an audio recognition engine 637, and to execute the voice-to-text converter code 631 to run a voice-to-text converter 639. The public announcement module 638 is operative to communicate with the WAN transceivers 609 and with the WLAN baseband hardware 611 and can establish an IP connection 626 with a server using a wireless interface implemented by either the WAN transceivers 609 or the WLAN baseband hardware 611. The public announcement module 638 is operative to obtain audio signatures from the server and store these in memory 603 as audio triggers 633 and/or audio templates 635. The public announcement module 638 is also operative to receive text files and audio stream files for audio public announcements from the server along with the audio signatures and to store these files in memory 603. Therefore the memory 603 may store the text versions of audio public announcements 636 in some embodiments. In some embodiments, these text files are indexed corresponding to audio template identification information that identifies the audio triggers 633 and/or the audio templates 635 such that when the audio recognition engine 637 detects one of these audio signatures it sends the corresponding audio template identification information to the public announcement module 638.

In some embodiments, the public announcement module 638 may then lookup the text version of the public announcement segment or segments in the text versions of audio public announcements 636 stored in memory, and display the public announcement on the display 605. In other embodiments, the public announcement module 638 may send the audio template identification information to the server over the IP connection 626 and receive back either a text file or an audio stream of the public announcement. The audio template identification information may be a numeric value that is included as a prefix or header of the text files that contain the text versions of audio public announcements. These prefixes may be stored in mobile device 600 memory 603 along with the audio templates 635. In other words, when an audio template 635 is detected the public announcement module 638 may retrieve the text file prefix and send that as the audio template identification information to the server. The server may then use the prefix to retrieve the corresponding text file and send it to the mobile device 600.

In some embodiments, the audio signatures (or portions thereof) may be used only as audio triggers 633 which wake the processor 601 from sleep mode when detected by a basic audio recognition engine 620. In this case, the audio trigger causes the processor 601 to wake and the audio recognition engine 637 listens to the entire audio public announcement (via the microphone and audio equipment 615). The voice-to-text converter 639 may then convert the recognized speech (actual human speech or synthesized speech) and display the public announcement textually on the display 605. The public announcement module 638 is also operative to communicate with GPS hardware 617, over the one or more internal communication buses 602, to obtain location information which it may then send to the server in order to obtain location related audio templates and other information such as text files and audio streams, etc.

Under certain mobile device 600 operating conditions, the processor 601 is placed in sleep mode in order to conserve battery power. One example of such operating conditions is when user activity stops or lulls for a predetermined period of time, such as a given number of minutes. When the processor 601 is operating in sleep mode, the sensor processor 619, which requires a lower amount of battery current than the processor 601, monitors the various sensors in order to detect user activity. Any user activity detected using the sensors may be used as a trigger to wake the processor 601. More particularly, the sensor processor 619 is operative to detect processor 601 “wake-up” triggers and send a wake up signal to the processor 601 over the one or more internal communication buses 602 in response to detecting one of the triggers.

One example wake-up trigger used in the various embodiments is an audio trigger. The sensor processor is operative to execute basic audio recognition engine code 632 from memory 603, to run a basic audio recognition engine 620. The basis audio recognition engine 620 is operative to detect limited audio signatures (i.e. audio template segments) such as the audio triggers 633 stored in memory 603. The audio triggers 633 may be an initial part of a sound, a single word, a simple short phrase, etc. Put another way, the basic audio recognition engine 620 is operative to recognize keywords, short phrases or sounds which may be included in, or precursory to, audio public announcements. The basic audio recognition engine 620 listens for an audio trigger 633 and, in response to detecting the audio trigger, will send a “wake up” command to wake the processor 601 from the low power state (i.e. wake from sleep mode). The processor 601 is operative to, among other things, launch and execute the audio recognition engine 637 and the voice-to-text convertor 639 upon receiving the wake up command. The audio recognition engine 637 will proceed to listen to the entirety of the audio public announcement. The voice-to-text converter 639 converts any speech portion of the audio public announcement into text that can be displayed on display 605.

It is to be understood that any of the above described example components, including those described as “modules” and “engines”, in the example mobile device 600, without limitation, may be implemented as software (i.e. executable instructions or executable code) or firmware (or a combination of software and firmware) executing on one or more processors, or using ASICs (application-specific-integrated-circuits), DSPs (digital signal processors), hardwired circuitry (logic circuitry), state machines, FPGAs (field programmable gate arrays) or combinations thereof. In embodiments in which one or more of these components is implemented as software, or partially in software/firmware, the executable instructions may be stored in the operatively coupled, non-volatile, non-transitory memory 603, or in flash memory or EEPROM on the processor chip, and/or on the same die, such that the software/firmware may be accessed by the processor 601, or other processors, as needed.

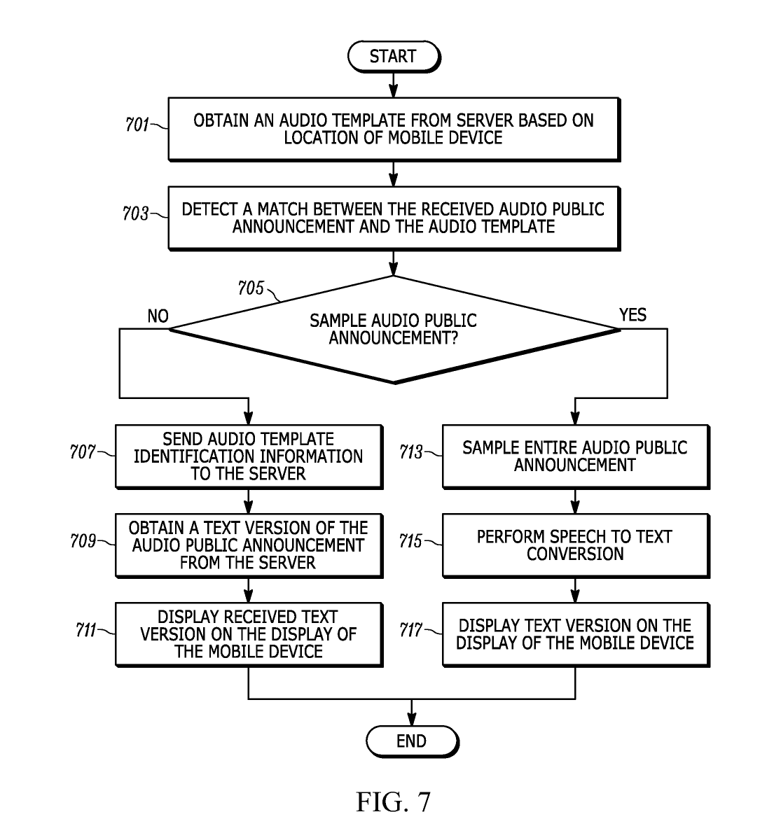

An example method of operation of the mobile device 600 that includes displaying a text version of an audio public announcement is illustrated in FIG. 7. The method of operation begins and in operation block 701, the public announcement module 638 communicates with a server over the IP connection 626 and obtains an audio template or audio trigger based on location of the mobile device 600. The mobile device 600 may obtain its location from the GPS hardware 617. However, the mobile device 600 may also obtain audio templates or audio triggers in advance of arriving at a given location. For example, the public announcement module 638 may communicate with a calendar application or with an email client of the mobile device 600 and obtain schedule and/or itinerary information for the mobile device 600 user. For example, if the user has scheduled a flight, the public announcement module 638 may obtain audio templates or audio triggers for the local airport prior to the user arriving at the airport, etc. Any obtained audio template may be stored in memory 603 as audio templates 635 and any obtained audio triggers may be stored in memory 603 as audio triggers 633.

In some embodiments, the public announcement module 638 communicates with the audio recognition engine 637 and segments any obtained audio templates 635 to generate the audio triggers 633. For example, the audio recognition engine 637 may process the audio templates 635 to extract initial keywords or short phrases and store these segments as the audio triggers 633. One example audio trigger may be the keyword “train” which would be an appropriate audio trigger in a train station setting where audio public announcements often begin with the work train (for example, “Train 636 is now approaching the station”). However the audio trigger need not be a complete word and may be only a portion of a word (i.e. such as a phoneme).

In operation block 703, the mobile device 600 detects a match between a received audio public announcement and the audio template. If the processor 601 is operating in sleep mode, then the basic audio recognition engine 620 will first detect an audio trigger 633 and send a wakeup command to the processor 601. The processor 601 will then execute the audio recognition engine 637 to recognize the entire audio template by comparing the received audio with the audio templates 635 stored in memory 603. In decision block 705, mobile device settings are checked to determine how to proceed. The mobile device settings may be stored in memory 603. The mobile settings allow the mobile device 600 user to specify whether the mobile device 600 should sample entire audio public announcements and perform speech-to-text conversion or whether the mobile device 600 should obtain text versions from the server.

In decision block 705, if the user has selecting settings for obtaining text versions from the server, then the mobile device 600 proceeds to operation block 707 and sends the audio template identification information to the server. The server then performs a database lookup operation using the audio template identification information and finds the text version of the corresponding audio public announcement. In operation block 709, the mobile device 600 obtains the text version of the audio public announcement from the server. In operation block 711, the mobile device 600 displays the text version of the audio public announcement on the display 605. The method of operation then terminates.

In decision block 705, if the user has selecting settings for sampling the entire audio public announcement, then the mobile device 600 proceeds to operation block 713 and samples the entire audio public announcement. In operation block 715, the voice-to-text converter 639 performs speech-to-text conversion of the sample audio public announcement. In operation block 717, the mobile device 600 displays the text version of the audio public announcement on the display 605. The method of operation then terminates.

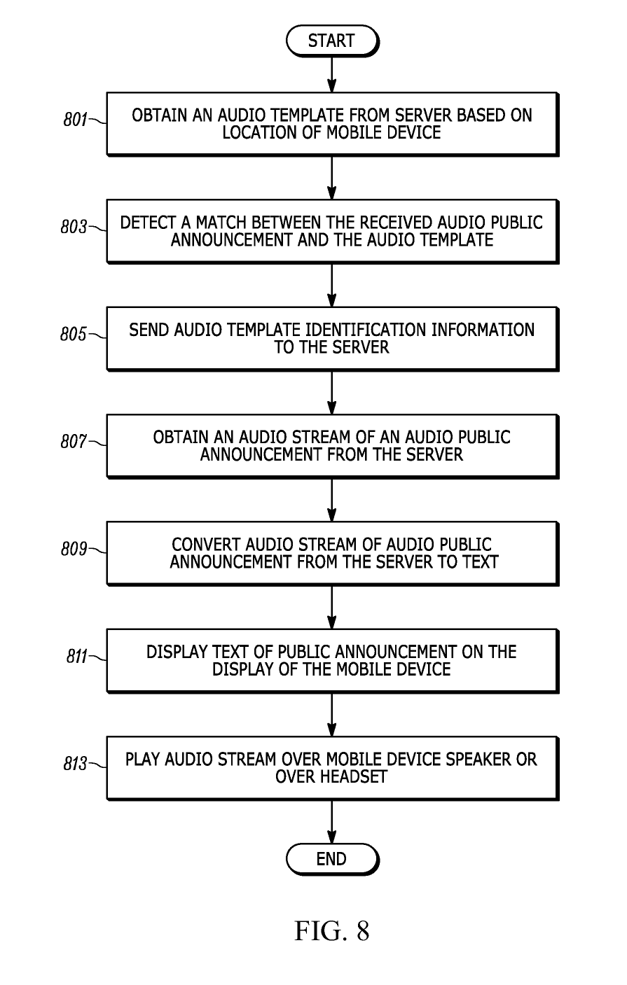

Another example method of operation of the mobile device 600 is shown in FIG. 8. The method of operation begins and in operation block 801, the mobile device 600 obtains an audio template from a server based on the mobile device 600 location. The audio template is stored in memory 603 as audio templates 635. At operation block 803, the mobile device 600 detects a match between a received audio public announcement and one of the audio templates 635 stored in memory 603. At operation block 805, the mobile device sends audio template identification information to the server. In operation block 807, the server sends an audio stream of the audio public announcement to the mobile device 600 in response to receiving the audio template identification information. In some embodiments, the server may send an audio file to the mobile device 600 using a push operation, or a download operation, such that the mobile device 600 can play the audio file directly. In other embodiments, the audio stream is received from the server. At operation block 809, the mobile device 600 may convert the audio stream or audio file into a text version. In operation block 811, the mobile device 600 may display the text version on the display 605. In operation block 813, the mobile device 600 may play the audio stream of the audio public announcement over the mobile device 600 speaker or over a headset accessory 612 if connected. The method of operation then terminates.

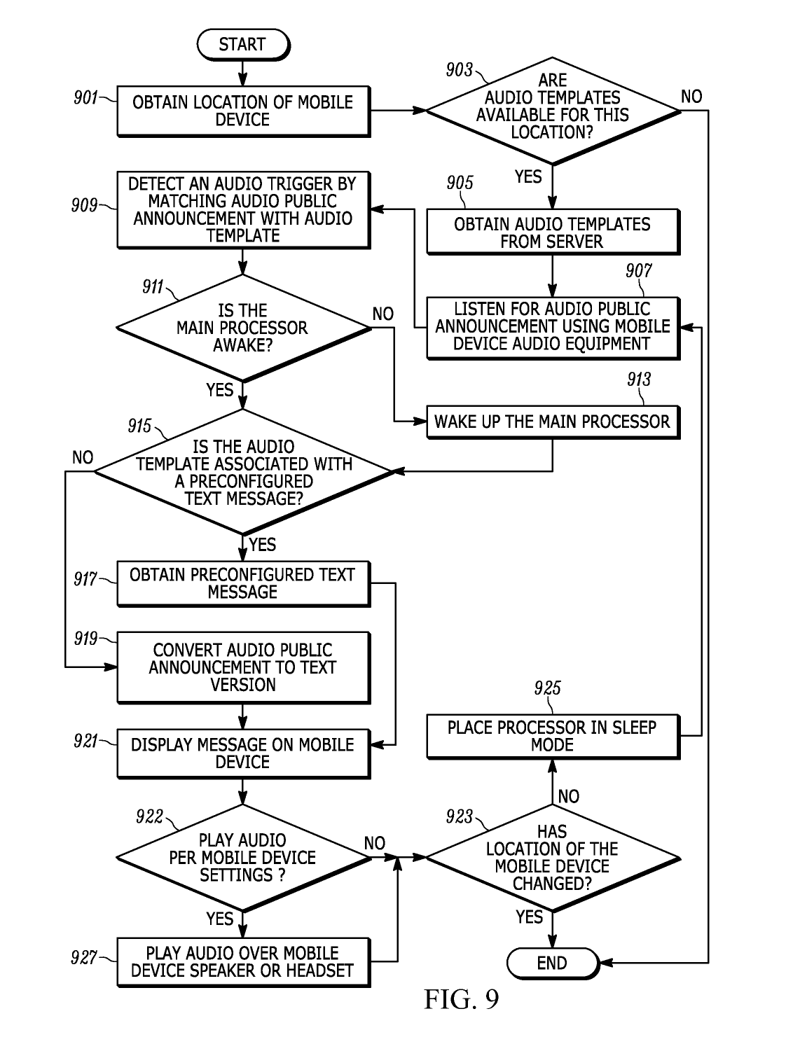

Another example method of operation of the example mobile device 600 shown in FIG. 6 is illustrated by the flowchart of FIG. 9. The method of operation begins and in operation block 901, the mobile device 600 obtains its location using the GPS hardware 617. In decision block 903, the mobile device 600 communicates with a server to determine whether audio templates are available for a public address system at the mobile device location. If no audio templates are available, the method of operation terminates as shown. If audio templates are available in decision block 903, then in operation block 905, the mobile device 600 will obtain the audio templates 635 and/or audio triggers 633 from the server and will store them in memory 603. In operation block 907, the mobile device 600 will listen for audio public announcements using the microphone, audio equipment 615 and either the audio recognition engine 637 or the basic audio recognition engine 620 if the processor 601 is in low power operation 640 (i.e. sleep mode). In operation block 909, the mobile device 600 will detect an audio signature by matching an audio public announcement with the audio templates 635, or a portion or segment of one of the audio templates. If the processor 601 is in sleep mode, then the basic audio recognition engine 620 will listen for audio triggers 633 which are used to wake the processor 601. Thus in decision block 911, if the processor 601 is in sleep mode, and one of the audio triggers 633 has been detected, then in operation block 913 the processor 601 will receive a wake up command from the sensor processor 619 and will wake up. The method of operation will then proceed to decision block 915. If the processor 601 is already awake in decision block 911, then the method of operation proceeds directly to decision block 915.

In decision block 915, the public announcement module 638 will determine whether a received audio public announcement is associated with a preconfigured public announcement stored in memory 603 or on the server. If yes, then in operation block 917 the public announcement module 638 will obtain the text version of the audio public announcement either from memory 603 or from the server and will display the text version on the display 605 as shown in operation block 921. In some embodiments, the public announcement module 638 may obtain the text version of the audio public announcement from a text message sent by the server, for example from a Short-Message-Service (SMS) message or from an Internet Messaging (IM) message. If the audio template is not associated with a preconfigured message, or if the embodiment is one that does not provide for access to preconfigured text versions of audio public announcements, then at operation block 919, the audio recognition engine 637 and the voice-to-text converter 639 will generate a text version of the audio public announcement. The method of operation will then proceed to operation block 921 and display the text version on display 605.

In decision block 922, the public announcement module 638 will check the mobile device 600 settings to determine if the user wants to have the audio public announcement played back over the mobile device 600 speaker or over a connected headset accessory 612. If yes, then in operation block 927 the public announcement module 638 will play the audio over either the speaker or over the headset accessory 612 if connected. The method of operation then proceeds to decision block 923. If the user does not want audio to be played in decision block 922, then the method of operation proceeds directly to decision block 923.

In decision block 923, the public announcement module 638 will determine whether the location of the mobile device 600 has changed by communicating with the GPS hardware 617. If the location has changed in decision block 923, then the method of operation will terminate as shown. However if the mobile device 600 location remains the same in decision block 923, then in operation block 925 the processor 601 will be again placed in sleep mode in order to conserve battery power, assuming that no other user activity causes the processor 601 to remain awake. In other words, operation block 925 is only implemented if user activity is at a lull, otherwise the method of operation proceeds directly to operation block 907. The method of operation therefore will loop back to operation block 907 such that the mobile device 600 will continue listening for audio public announcements until the mobile device 600 leaves the location of the public address system. If the processor 601 is placed into sleep mode, then the basic audio recognition engine 620 will listen for audio triggers 633 and wake the processor 601 if any audio triggers 633 are detected. The audio recognition engine 637 will then take over the audio detection operation. If the processor 601 is already awake, the audio detection operation will be performed directly by the audio recognition engine 637 which will listen for audio templates 635.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. A method comprising:
running audio recognition on a mobile device operating in a low power state;
waking a processor from the low power state in response to detecting an audio trigger corresponding to an audio public announcement at a location of the mobile device;
receiving the audio public announcement; and
displaying a text version of the audio public announcement on a display of the mobile device.

2. The method of claim 1, further comprising:
obtaining an audio template from a server based on location of a mobile device, the audio template defining the audio trigger related to a public address system at the location.

3. The method of claim 1 wherein waking the processor from the low power state in response to detecting an audio trigger comprises:
detecting the audio trigger where the audio trigger is a spoken word, sound or combination thereof from a public address system.

4. The method of claim 2, further comprising:
obtaining the text version of the audio public announcement from the server, the text version associated with the audio template.

5. The method of claim 1, further comprising:
converting the audio public announcement into the text version of the audio public announcement by performing a voice-to-text conversion.

6. The method of claim 4, further comprising:
detecting a match between the received audio public announcement and the audio template;
sending audio template identification information to the server, in response to detecting the match; and
obtaining the text version of the audio public announcement from the server in response to sending the audio template identification information.

7. The method of claim 4, further comprising:
detecting a match between the received audio public announcement and the audio template;
sending audio template identification information to the server, in response to detecting the match; and
obtaining an audio stream of the audio public announcement from the server in response to sending the audio template identification information.

8. The method of claim 1, further comprising:
detecting a match between the audio public announcement and an audio template stored on a server; and
obtaining the text version of the audio public announcement from the server in response to detecting the match.

9. The method of claim 1, further comprising:
detecting a match between the audio public announcement and an audio template stored on a server; and
obtaining an audio stream of the audio public announcement from the server in response to detecting the match.

10. The method of claim 9, further comprising:
playing the audio stream of the audio public announcement over a headset accessory connected to the mobile device.

11. A mobile device comprising:
at least one microphone;
a display;
a first processor, operatively coupled to the microphone and to the display, the first processor operative to receive an audio public announcement and display a text version of the audio public announcement on the display;
a second processor, operatively coupled to the first processor, the microphone and to the display, the second processor operative to:
run audio recognition while the first processor operates in a low power state; and
wake the first processor from the low power state in response to an audio trigger detected using the microphone, the audio trigger corresponding to an audio public announcement at a location of the mobile device.

12. The mobile device of claim 11, wherein the first processor is further operative to:
obtain an audio template from a server based on location of a mobile device, the audio template defining the audio trigger related to a public address system at the location.

13. The mobile device of claim 11, wherein the first processor is further operative to:
wake from the low power state in response to the second processor detecting an audio trigger where the audio trigger is a spoken word, sound or combination thereof from a public address system.

14. The mobile device of claim 11, wherein the first processor is further operative to:
obtain the text version of the audio public announcement associated with the audio template from the server.

15. The mobile device of claim 11, wherein the first processor is further operative to:
convert the audio public announcement into the text version of the audio public announcement by performing a voice-to-text conversion.

16. The mobile device of claim 14, wherein the first processor is further operative to:
detect a match between the received audio public announcement and the audio template;
send audio template identification information to the server, in response to detecting the match; and
obtain the text version of the audio public announcement from the server in response to sending the audio template identification information.

17. The mobile device of claim 14, wherein the first processor is further operative to:
detect a match between the received audio public announcement and the audio template;
send audio template identification information to the server, in response to detecting the match; and
obtain an audio stream of the audio public announcement from the server in response to sending the audio template identification information.

18. The mobile device of claim 11, wherein the first processor is further operative to:
detect a match between the audio public announcement and an audio template stored on the server; and
obtain the text version of the audio public announcement from the server in response to detecting the match.

19. The mobile device of claim 11, wherein the first processor is further operative to:
detect a match between the audio public announcement and an audio template stored on the server; and
obtain an audio stream of the audio public announcement from the server in response to detecting the match.

20. The mobile device of claim 19, further comprising:
a headset jack operatively coupled to the first processor;
wherein the first processor is further operative to play the audio stream of the audio public announcement over a headset accessory connected to the mobile device via the headset jack.
